(19) United States
(12) Patent Application Publication
(10) Pub. No.: US 2025/0248335 A1
(43) Pub. Date: Aug. 7, 2025

(54) RESIDUE OSCILLATING DEFLECTOR SPEED COUPLED TO GROUND SPEED OF COMBINE

(71) Applicant: CNH Industrial America LLC, New Holland, PA (US)

(72) Inventors: Cooper Linde, Lancaster, PA (US); Zachary Harmon, Robesonia, PA (US); Nathan E. Isaac, Lancaster, PA (US)

(73) Assignee: CNH Industrial America LLC, New Holland, PA (US)

(21) Appl. No.: 18/435,498

(22) Filed: Feb. 7, 2024

(51) Int. Cl. A01D 41/127; A01D 41/12

(52) U.S. Cl. CPC A01D 41/1271; A01D 41/1243

(57) ABSTRACT

A combine harvester including a feeder housing for receiving harvested crop, a separating system for threshing the harvested crop to produce grain and residue, a residue spreader, a continuously oscillating residue deflector for deflecting the expelled residue, and a controller. The controller is configured to determine a combine harvester ground speed, a spreader impeller speed, and/or a combine throughput heading of the combine, and to vary the deflector oscillating frequency according to at least one of combine harvester ground speed, spreader impeller speed, and combine throughput, for a more even distribution of expelled residue. Oscillation frequency of the deflector may also be varied according to feedback from sensors detecting residue distribution by the spreader or according to combine operator input.

### FIELD OF THE INVENTION

The present invention relates to agricultural machines, in particular, combine harvesters. More specifically, the present invention relates to a crop residue spreader for a combine harvester.

### BACKGROUND OF THE INVENTION

Rotary threshing or separating systems are used in combine harvesters for threshing crops to separate grain from crop residue, also referred to as material other than grain (MOG). Such axially arranged systems typically include at least one cylindrical rotor rotated within a cage or concave, with the rotor and surrounding concave being oriented so as to extend forwardly to rearwardly within the combine harvester.

During operation of the combine harvester, crop material is fed or directed into a circumferential passage between the rotor and the concave and is carried rearwardly along a generally helical path through such passage by rotation of the rotor as grain is threshed from the crop material. The flow of crop residue remaining between the rotor and concave after threshing is typically discharged or expelled at a rear or downstream end of the rotor.

After discharge from the threshing system, the crop residue is typically directed into a crop residue distribution system located below and rearwardly of the rear end of the rotor. The crop residue distribution system typically includes a rotary beater or chopper or other apparatus that conveys and/or chops and propels the residue rearwardly towards an area within the rear end of the combine, hereinafter referred to as a distribution chamber. The crop residue provided within the distribution chamber may be (i) discharged therefrom onto a field as a windrow, (ii) directed into a crop residue spreader mounted on or at the rear end of the combine that is operable for spreading the residue over a swath of a field, or (iii) both (i) and (ii).

Windrowing typically occurs when users desire to retain the crop residue for post-processing. In such cases, the residue, which may be chopped or un-chopped, is discharged from the combine, without entering the chopper/spreader, to form a windrow directly behind the combine. A windrow door is typically positioned at the rear opening and is pivotable between a closed position, wherein the crop residue is diverted into the spreader, and an open position, wherein the crop residue is directed over the spreader, through the rear opening, onto a windrow chute and onto the field. When the crop residue is to be discharged onto a field to form a windrow, it is typically preferred that the crop residue be distributed onto the windrow chute extending from the rear opening to allow for the formation of a desirable windrow shape.

A crop residue spreader mounted on or at the rear end of the combine is configured to distribute the processed crop materials or residue over a harvested field. Spreader assemblies typically include counter rotating disks or impellers mounted on a frame for receiving all or part of the processed crop material or residue from the distribution chamber and spreading the material in a generally even side to side manner behind the harvester.

The spreader assembly may include a transition hood, also known as a distribution hood or a spreader hood, specially configured for spreading chaff in a uniform manner and positioned at or near the outlet of the impellers. The transition hood may be provided with a stationary or movable (oscillating) deflector to modify the distribution of the crop residue exiting the rotary disks, for example, to deposit crop residue more evenly across the width of the harvester or across the distribution area behind the harvester.

Operators may set residue spreader parameters to achieve a desired spread. A continuously moving oscillating deflector helps to spread the residue out of the back of the combine evenly over the field, without an additional operator input. As the combine speeds up, the oscillating deflector can leave linear or arced stripes in the field that have heavy areas of residue and then light areas of residue (i.e., striping). Ground speed of the combine has been observed to have a significant effect on the prominence of the stripes in the field.

In view of the foregoing, it would be desirable to provide a spreader assembly capable of being configured to improve distribution of expelled crop residue material more evenly over a field in response to changing operating conditions.

Although various components of agricultural harvesters are mentioned in the Background section, such disclosure is not an admission that those components are admitted prior art.

### SUMMARY OF THE INVENTION

According to one aspect of the invention, a combine harvester comprises: a feeder housing for receiving harvested crop; a separating system for threshing the harvested crop to produce grain and residue; a residue spreader comprising one or more impellers for expelling the residue from the combine; a continuously oscillating residue deflector positioned to deflect residue expelled by the impellers; and a controller configured to: 1) determine a ground speed of the combine harvester; 2) determine a rotating speed of the one or more impellers; and/or 3) determine a throughput of the combine harvester; and 4) adjust an oscillating frequency of the residue deflector to achieve a desired residue distribution, based on the ground speed of the combine harvester, the rotating speed of the one or more impellers, and/or the throughput of the combine harvester.

According to another aspect of the invention, the combine harvester further comprises one or more sensors to detect residue expelled by the combine, wherein the controller is further configured to receive a signal from the one or more sensors indicating a detected residue distribution, to determine whether the detected residue distribution has an undesired feature, and, upon determining the detected residue distribution has an undesired feature, to adjust the oscillating frequency of the residue deflector to mitigate the undesired feature of the detected residue distribution.

According to another aspect of the invention, the oscillating frequency of the residue deflector may be varied by an operator of the combine harvester.

According to another aspect of the invention, a hydraulic motor drives the continuously oscillating residue deflector.

According to another aspect of the invention, an electric motor drives the continuously oscillating residue deflector.

According to another aspect of the invention, the undesired residue distribution feature comprises striping of the residue on the ground.

According to another aspect of the invention, the oscillating frequency of the residue deflector is increased in response to one or more of an increase in the ground speed of the combine harvester, an increase in the rotating speed of the one or more impellers, or an increase in the throughput of the combine harvester.

According to another aspect of the invention, the oscillating frequency of the residue deflector is increased in response to the controller determining the detected residue distribution comprises striping of the residue on the ground.

According to another aspect of the invention, a method for controlling a combine comprising a feeder housing for receiving harvested crop, separating system for threshing the harvested crop to produce grain and residue, a residue spreader comprising one or more impellers for expelling the residue from the combine, a continuously oscillating residue deflector positioned to deflect residue expelled by the impellers, and a controller is provided, the method comprising: 1) determining, by the controller, a ground speed of the combine harvester; 2) determining, by the controller, a rotating speed of the one or more impellers; and/or 3) determining, by the controller, a throughput of the combine harvester; and 4) adjusting, by the controller, an oscillating frequency of the residue deflector to achieve a desired residue distribution, based on the ground speed of the combine harvester, the rotating speed of the one or more impellers, and/or the throughput of the combine harvester.

According to another aspect of the invention, a method is provided, wherein the combine harvester further comprises one or more sensors to detect residue expelled by the combine, and wherein the method further comprises the controller receiving a signal from the one or more sensors indicating a detected residue distribution, determining whether the detected residue distribution has an undesired feature, and, upon determining the detected residue distribution has an undesired feature, adjusting the oscillating frequency of the residue deflector to mitigate the undesired feature of the detected residue distribution.

According to another aspect of the invention, a method is provided, further comprising varying, by an operator of the combine harvester, the oscillating frequency of the residue deflector.

According to another aspect of the invention, a method is provided, wherein the undesired feature of the detected residue distribution comprises striping of the residue on the ground.

According to another aspect of the invention, a method is provided, comprising increasing the oscillating frequency of the residue deflector in response to one or more of an increase in the ground speed of the combine harvester, an increase in the rotating speed of the one or more impellers, or an increase in the throughput of the combine harvester.

According to another aspect of the invention, a method is provided, comprising increasing the oscillating frequency of the residue deflector in response to the controller determining the detected residue distribution comprises striping of the residue on the ground.

According to another aspect of the invention, a method is provided, comprising increasing the oscillation frequency of the residue deflector in response to the controller determining the detected residue distribution has striping of the residue on the ground.

### BRIEF DESCRIPTION OF THE DRAWING FIGURES

The above-mentioned and other features and advantages of this invention, and the manner of attaining them, will become more apparent, and the invention will be better understood, by reference to the following description of an embodiment of the invention taken in conjunction with the accompanying drawings, wherein:

FIG. 1 is a side elevation view of a combine harvester, shown schematically;

FIGS. 2 and 3 are isometric views of an embodiment of a crop residue spreader formed according to the present invention;

FIG. 4 is a partially-exploded isometric view of the crop residue spreader of FIG. 3, shown with windrow chute (also known as a swath board);

FIG. 5 is a rear elevation view of an embodiment of a crop residue spreader formed according to the present invention, showing details of the distribution hood and oscillating deflector;

FIG. 6 is a schematic view of a control system;

FIG. 7 is a flowchart of steps for controlling oscillating deflector parameters based on a signal from the one or more sensors indicating a detected residue distribution, according to an embodiment of the invention; and

FIG. 8 is a flowchart of steps for controlling oscillating deflector parameters based on one or more of the ground speed of the combine harvester, the rotating speed of the one or more impellers, or the throughput of the combine harvester, according to an embodiment of the invention.

### DETAILED DESCRIPTION

Corresponding reference characters indicate corresponding parts throughout the several views. The exemplifications set out herein illustrate one or more embodiments of the invention, in the described forms, and such exemplification is not to be construed as limiting the scope of the invention in any manner.

Inasmuch as various components and features of harvesters are of well-known design, construction, and operation to those skilled in the art, the details of such components and their operations will not generally be discussed in significant detail unless considered of pertinence to the present invention or desirable for purposes of better understanding.

In the drawings, like numerals refer to like items, certain elements and features may be labeled or marked on a representative basis without each like element or feature necessarily being individually shown, labeled, or marked, and certain elements are labeled and marked in only some, but not all, of the drawing figures.

The terms “grain”, “chaff”, “straw”, and “tailings” are used principally throughout this specification for convenience but it is to be understood that these terms are not intended to be limiting. Thus, “grain” refers to that part of the crop material that is threshed and separated from the part of the crop material to be discarded, which is referred to as chaff and includes straw, and other non-grain crop material.

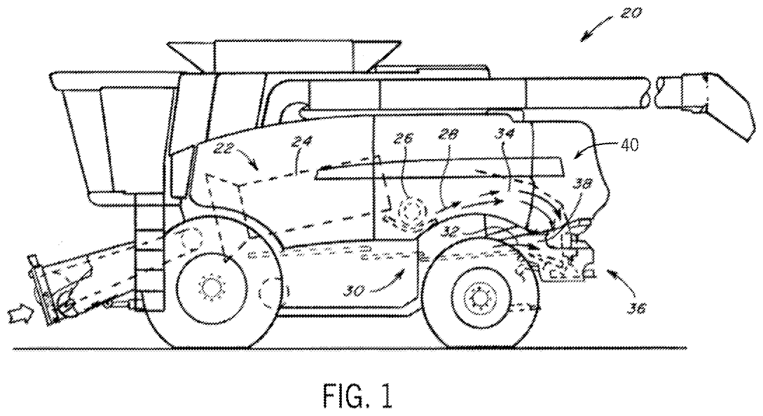

Also, the terms “forward”, “rearward”, “left” and “right”, when used in connection with the agricultural harvester and/or components thereof, are usually determined with reference to the direction of forward operative travel of the harvester, but again, they should not be construed as limiting. The terms “longitudinal” and “transverse” are determined with reference to the fore-and-aft direction of the agricultural harvester and are equally not to be construed as limiting. The terms “upstream” and “downstream” are determined with reference to the crop flow stream arrows shown in FIG. 1.

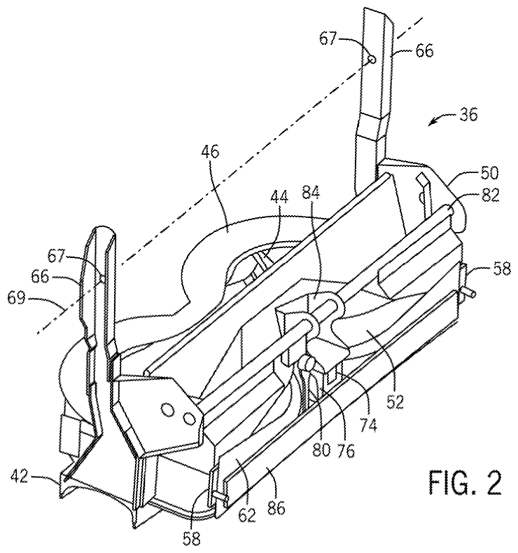

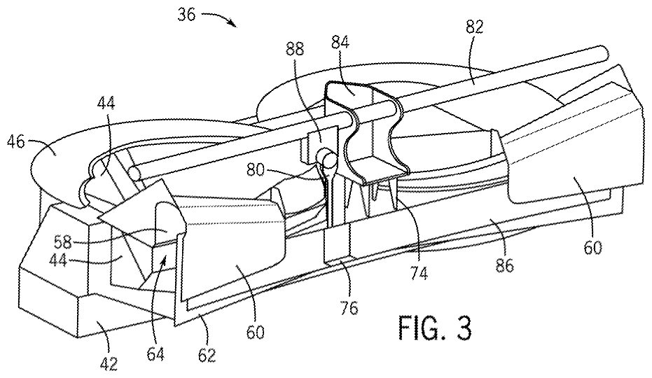

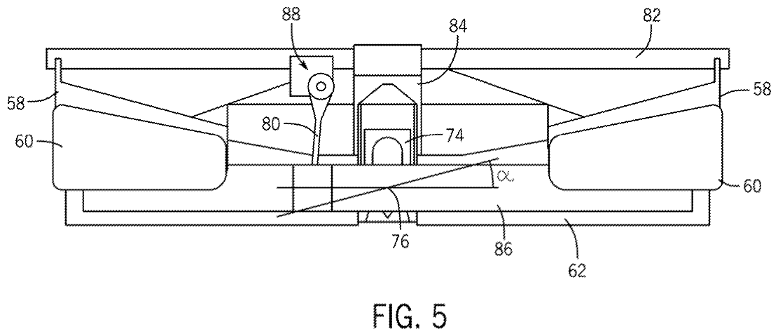

Referring now to the drawings, and more particularly to FIG. 1, there is shown an agricultural combine 20. Combine 20 includes a threshing system 22 having a rotor 24 rotatable for separating straw 28 from the harvested crop, and a beater 26 rotatable for propelling or directing a flow or stream of straw 28 rearwardly along an airborne trajectory through a rear cavity 34 enclosed by a straw hood 40. Combine 20 also includes a cleaning system 30 for receiving the harvested crop from threshing system 22 and removing chaff 32 from the grain and directing a flow or stream of chaff 32 rearwardly through a lower region of rear cavity 34, towards a lower opening 38 in which a crop residue spreader 36, is shown located, constructed and operable according to the present invention. FIGS. 2-5 depict in greater detail the crop residue spreader 36.

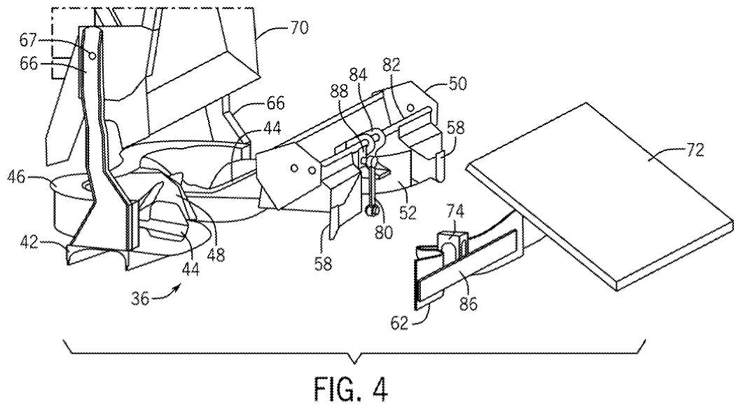

Referring now to FIGS. 2 through 5, there is shown a crop residue spreader 36 for an agricultural harvester 20, including a structural member in the form of a pair of swing arms 66 for mounting the spreader 36 to the straw hood 40. According to a preferred aspect of the invention as shown in FIGS. 2 and 4, spreader 36 is supported for pivotable movement relative to straw hood 40 about an axis 69 defined by pivot points 67 on swing arms 66.

Spreader frame 42 is mounted to swing (or pivot) arms 66, and mounted on spreader frame 42 are a pair of counter-rotating impellers 44. Impellers 44 are configured to receive a crop residue (i.e., straw 28 and/or chaff 32) from, for example, the threshing system 22 and/or cleaning system 30 of the harvester 20 through lower opening 38. Impellers 44 are at least partially surrounded by housing 46, the housing 46 being substantially open in the rearward direction to allow the impellers 44 to discharge the crop residue to the rear of the harvester 20. A center section 48 of the impeller housing 46 extends and tapers rearwardly between the impellers 44, partially separating and dividing the impellers 44. Impellers 44 may also be provided with movable hoods (not shown) to modify the flow of crop residue exiting the impeller housing 46. An example of such a movable impeller housing is described in U.S. Pat. No. 9,370,141, the entire disclosure of which is incorporated herein by reference in its entirety and for all purposes. Distribution hood 50 is mounted on swing arms 66 in close proximity to the impellers 44 and impeller housing 46 in a rearward direction facing the discharge of crop residue from the impellers 44.

Distribution hood 50 includes distribution hood divider 52, divider wings 58, and distribution hood frame 82. Suspended from the midpoint of distribution hood frame 82 and at least partially housed within divider 52 is deflector mounting bracket 84, which supports oscillating deflector 62. Aft of divider 52 and divider wings 58, oscillating deflector 62 is mounted to deflector mounting bracket 84 via deflector shaft mount 74. Upper opening 70 is positioned generally above distribution hood 50 at the rear of straw hood 40 to enable discharge from combine 20 of residue flow 28 guided within straw hood 40 around residue spreader 36 and distribution hood 50. Extending rearwardly over distribution hood 50 from upper opening 70 is windrow chute (or swath board) 72. Windrow chute (or swath board) 72 is or may be mounted on spreader frame 42. Rear baffle 60 is suspended from transition hood frame 84 aft of oscillating deflector 62 and deflector frame 86, forming recess 64 between rear baffle 60 and separator wings 58. In operation, deflector 62 oscillates at least partly into and out of recess 64 to alter the trajectory of crop residue ejected from the impeller housing 46 by impellers 44.

Oscillating deflector 62 is mounted on the distribution hood 50. At least partly enclosed within distribution hood divider 52, deflector mount bracket 84 is suspended from distribution hood frame 82. Deflector shaft mount 74 is bolted to deflector mount bracket 84 and supports deflector shaft 76. Deflector shaft connects to deflector frame 86, and oscillating deflector 62 is mounted on deflector frame 86. Deflector driver 88 is connected to deflector frame 86 by pitman arm 80 and drives movement of deflector shaft 76 in a rotational, oscillatory pattern.

The deflector driver 88 may use any type of power, such as electrical, mechanical, or hydraulic power, to move the deflector 62. In one embodiment, deflector driver 88 can be, for example, a motor that is adapted to rotate deflector shaft 76 a predetermined number of degrees from a neutral position and then return deflector shaft 76 to the neutral position. Such motors are commonly employed to drive windshield wipers on various types of vehicles and can be readily adapted to use according to the present invention. By constantly oscillating the movement of the deflector 62 in this fashion, stripes of crop residue being formed on the field can be reduced or avoided by constantly varying the deflection pattern of the crop residue. For example, deflector driver 88 can oscillate the deflector 62 with an oscillation amplitude 2α of about 60° from a neutral position, but it is also contemplated that the oscillation amplitude 2α can be other values between 30° and 120°. A similar effect can also be obtained by linearly moving the deflector 62 from side-to-side with a deflector driver 88 that reciprocates the deflector 62, with many types of drivers (not illustrated) that can create reciprocating movement being known. Each stroke of the reciprocating movement can be adjusted to achieve a desired spread pattern.

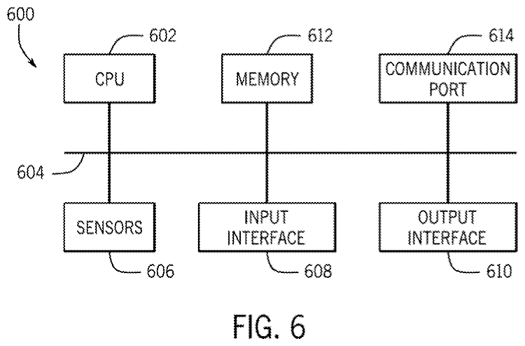

An example of a deflector oscillation frequency control system 600 is shown in FIG. 6. The control system 600 may be implemented using any suitable arrangement of processors and logical circuits. FIG. 6 is a block diagram of exemplary hardware and computing equipment that may be used as a control system 600. The control system 600 includes a central processing unit (CPU) 602, which is responsible for performing calculations and logic operations required to execute one or more computer programs or operations. The CPU 602 is connected via a data transmission bus 604, to sensors 606 (e.g., sensors for detecting deflector driver speed, combine ground speed, impeller rotating speed, combine throughput, and residue distribution), an input interface 608, an output interface 610, and a memory 612. The input and output interfaces 608, 610 may comprise any suitable user-operable and perceivable system, such as a touchscreen controller/display, control knobs or joysticks, and the like. One or more analog to digital conversion circuits may be provided to convert analog data from the sensors 606 to an appropriate digital signal for processing by the CPU 602, as known in the art. The CPU 602 also may be operatively connected to one or more communication ports 614, such as serial communication ports, wireless communication ports (e.g., cellular or Bluetooth communication chipsets), or the like.

The CPU 602, data transmission bus 604 and memory 612 may comprise any suitable computing device, such as an INTEL ATOM E3826 1.46 GHz Dual Core CPU or the like, being coupled to DDR3L 1066/1333 MHZ SO-DIMM Socket SDRAM having a 4 GB memory capacity or other memory (e.g., compact disk, digital disk, solid state drive, flash memory, memory card, USB drive, optical disc storage, etc.). The selection of an appropriate processing system and memory is a matter of routine practice and need not be discussed in greater detail herein.

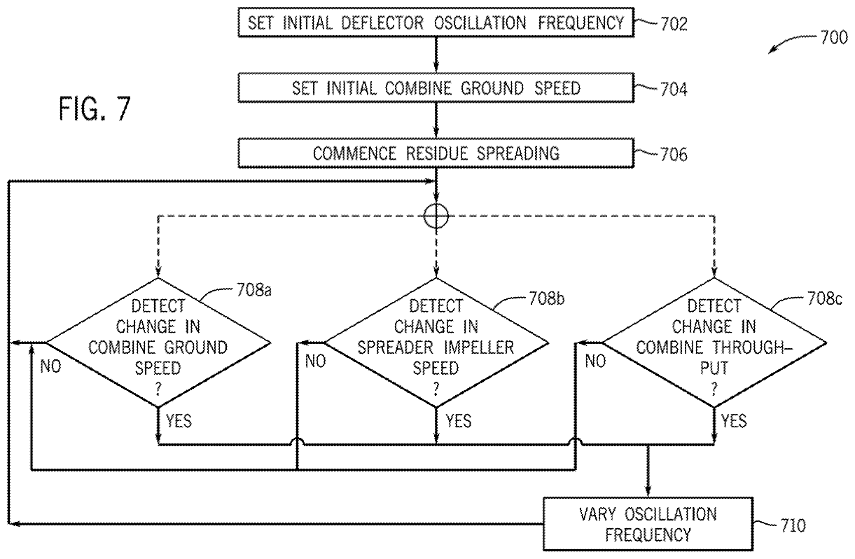

FIG. 7 shows a flowchart of a method 700 for controlling the deflector oscillation frequency, based on one or more of a ground speed of the combine harvester, a rotating speed of the one or more impellers, and/or a throughput of the combine harvester. In step 702, the controller sets an initial deflector oscillation frequency to a predetermined value or by receiving operator input through the input interface 608. Initially setting the deflector oscillating frequency may be performed in a number of different manners. For example, the initial deflector oscillating frequency may simply be determined from a pre-stored table that is populated based on experiments, operator experience, algorithms, or the like.

In step 704, the controller sets an initial combine ground speed to a predetermined value or by receiving operator input through the input interface 608. In step 706, residue spreading commences. Following commencement of residue spreading in step 706, the controller determines one or more of combine ground speed (708a), the spreader impeller rotating speed (708b), and/or the combine throughput (708c) by receiving operator input through the input interface 608 (e.g. the operator can enter combine ground speed, spreader impeller rotating speed, and/or combine throughput), or by receiving signals from sensors 606 for measuring these operating parameters. Upon determining that one of these operating parameters has changed, the controller in step 710 correspondingly varies the deflector oscillation frequency to continue residue spreading.

In step 710, the controller varies the deflector oscillation frequency to mitigate undesired residue distribution qualities such as striping of the expelled residue across the ground. In one embodiment, in response to determining in step 708a that the ground speed of the combine has increased from the initial ground speed, or in step 708b that the spreader impeller rotating speed has increased, or in step 708c that the combine throughput has increased, the controller will in step 710 increase the deflector oscillation frequency. In another embodiment, the controller in step 710 will decrease the deflector oscillation frequency in response to a change detected in one or more of the combine ground speed, the spreader impeller rotating speed, or the combine throughput.

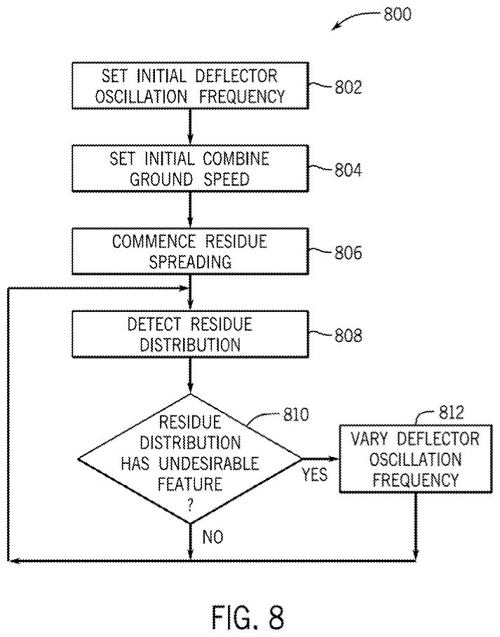

FIG. 8 shows a flowchart of a method 800 for controlling the deflector oscillation frequency, based on a detected residue distribution. In step 802, the controller sets an initial deflector oscillation frequency to a predetermined value or by receiving operator input through the input interface 608. As in the method 700 of FIG. 7, initially setting the deflector oscillating frequency may be performed in a number of different manners. For example, the initial deflector oscillating frequency may simply be determined from a pre-stored table that is populated based on experiments, operator experience, algorithms, or the like.

In step 804, the controller sets an initial combine ground speed to a predetermined value or by receiving operator input through the input interface 608. In step 806, residue spreading commences. Following commencement of residue spreading in step 806, the controller in step 808 receives a signal from the one or more sensors 606 indicating a detected residue distribution. Sensors 606 (e.g., camera, radar) may be mounted to the rear of the combine and captures images and/or data of the residue spread on the ground. The controller 600 then analyzes the images and/or data using known image and/or data processing techniques to determine the desirability of the spread.

If the residue spread is deemed by the controller in step 810 to be desirable, no adjustments to the deflector oscillating frequency are made. However, if the residue spread is deemed by the controller 810 to be undesirable, adjustments to the deflector oscillating frequency are made by the controller in step 812. For example, the deflector oscillating frequency may be increased or decreased until the observable residue spread is desirable (e.g. uniformly spread on the ground). Once these adjustments are made, the controller then uses these adjusted values for controlling the deflector oscillating frequency for further harvesting and residue spreading.

In another embodiment, in addition or as an alternative to varying the deflector oscillating frequency, the stroke or amplitude of the deflector oscillation may be varied according to one or more of the combine ground speed, the spreader impeller rotating speed, the combine throughput, or a detected residue spread distribution.

In an embodiment, wherein the oscillating residue deflector is driven by a hydraulic motor, the hydraulic valve setup and controller can be configured so that the motor gets more flow (spins faster) as the ground speed of the combine is increased. In another embodiment, wherein the oscillating residue deflector is driven by an electric motor, the RPM of the electric motor can be increased/decreased as the ground speed of the combine is changed. In another embodiment, the spreader impeller rotating speed is varied based on a detected residue distribution (i.e., feedback from the residue radar sensors) for a more even spread distribution.

In another embodiment, the operator may observe (e.g. through a mirror or through a video feed from a camera located at the rear of the combine) the residue spread on the ground. If the residue spread is deemed by the operator to be undesirable, the operator may enter adjustments to the deflector oscillation frequency, increasing or decreasing until the observable residue spread is desirable (e.g. uniformly spread on the ground). Once these adjustments are made, the controller may use these adjusted values for controlling the deflector oscillating frequency for further harvesting and residue spreading.

It is to be understood that the above-described operating steps are performed by the controller 600 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the controller 600 described herein, such as the aforementioned method of operation, is implemented in software code or instructions which are tangibly stored on the tangible computer readable medium. Upon loading and executing such software code or instructions by the controller 600, the controller 600 may perform any of the functionality of the controller 600 described herein, including any steps of the aforementioned method described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

Although the invention is illustrated and described herein with reference to specific embodiments, the invention is not intended to be limited to the details shown. Rather various modifications may be made in the details within the scope and range of equivalence of the claims and without departing from the invention.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A combine harvester comprising:
a feeder housing for receiving harvested crop;
a separating system for threshing the harvested crop to produce grain and residue;
a residue spreader comprising one or more impellers for expelling the residue from the combine;
a continuously oscillating residue deflector positioned to deflect residue expelled by the impellers; and
a controller configured to:
1) determine a ground speed of the combine harvester;
2) determine a rotating speed of the one or more impellers; and/or
3) determine a throughput of the combine harvester; and
4) adjust an oscillating frequency of the residue deflector to achieve a desired residue distribution, based on the ground speed of the combine harvester, the rotating speed of the one or more impellers, and/or the throughput of the combine harvester.

2. The combine harvester of claim 1, further comprising one or more sensors to detect residue expelled by the combine, wherein the controller is further configured to receive a signal from the one or more sensors indicating a detected residue distribution, to determine whether the detected residue distribution has an undesired feature, and, upon determining the detected residue distribution has an undesired feature, to adjust the oscillating frequency of the residue deflector to mitigate the undesired feature of the detected residue distribution.

3. The combine harvester of claim 1, wherein the oscillating frequency of the residue deflector may be varied by an operator of the combine harvester.

4. The combine harvester of claim 1, wherein a hydraulic motor drives the continuously oscillating residue deflector.

5. The combine harvester of claim 1, wherein an electric motor drives the continuously oscillating residue deflector.

6. The combine harvester of claim 2, wherein the undesired residue distribution feature comprises striping of the residue on the ground.

7. The combine harvester of claim 1, wherein the oscillating frequency of the residue deflector is increased or decreased in response to one or more of an increase in the ground speed of the combine harvester, an increase in the rotating speed of the one or more impellers, or an increase in the throughput of the combine harvester.

8. The combine harvester of claim 6, wherein the oscillating frequency of the residue deflector is increased in response to the controller determining the detected residue distribution comprises striping of the residue on the ground.

9. A method for controlling a combine comprising a feeder housing for receiving harvested crop, separating system for threshing the harvested crop to produce grain and residue, a residue spreader comprising one or more impellers for expelling the residue from the combine, a continuously oscillating residue deflector positioned to deflect residue expelled by the impellers, and a controller, the method comprising:
1) determining, by the controller, a ground speed of the combine harvester;
2) determining, by the controller, a rotating speed of the one or more impellers; and/or
3) determining, by the controller, a throughput of the combine harvester; and
4) adjusting, by the controller, an oscillating frequency of the residue deflector to achieve a desired residue distribution, based on the ground speed of the combine harvester, the rotating speed of the one or more impellers, and/or the throughput of the combine harvester.

10. The method of claim 9, wherein the combine harvester further comprises one or more sensors to detect residue expelled by the combine, and wherein the method further comprises the controller receiving a signal from the one or more sensors indicating a detected residue distribution, determining whether the detected residue distribution has an undesired feature, and, upon determining the detected residue distribution has an undesired feature, adjusting the oscillating frequency of the residue deflector to mitigate the undesired feature of the detected residue distribution.

11. The method of claim 9, further comprising varying, by an operator of the combine harvester, the oscillating frequency of the residue deflector.

12. The method of claim 10, wherein the undesired feature of the detected residue distribution comprises striping of the residue on the ground.

13. The method of claim 9, comprising increasing the oscillating frequency of the residue deflector in response to one or more of an increase in the ground speed of the combine harvester, an increase in the rotating speed of the one or more impellers, or an increase in the throughput of the combine harvester.

14. The method of claim 12, comprising increasing the oscillating frequency of the residue deflector in response to the controller determining the detected residue distribution comprises striping of the residue on the ground.

15. The method of claim 12, comprising decreasing the oscillation frequency of the residue deflector in response to the controller determining the detected residue distribution has striping of the residue on the ground.
